(19) United States
(12) Patent Application Publication
(10) Pub. No.: US 2022/0281215 A1
(43) Pub. Date: Sep. 8, 2022

(54) BONDING FIXTURE AND BONDING DEVICE WITH THE SAME

(71) Applicants: Chengdu BOE Optoelectronics Technology Co., Ltd., Chengdu (CN); BOE Technology Group Co., Ltd., Chengdu (CN)

(72) Inventors: Jia DENG, Beijing (CN); Haitao LIANG, Beijing (CN); Jialin WANG, Beijing (CN); Rongkun FAN, Beijing (CN); Peng WANG, Beijing (CN); Chaoxue QIN, Beijing (CN); Zhiwei DANG, Beijing (CN); Xinyu REN, Beijing (CN)

(21) Appl. No.: 17/511,355

(22) Filed: Oct. 26, 2021

(30) Foreign Application Priority Data
Mar. 4, 2021 (CN) 202110240751.0

(51) Int. Cl. B32B 38/18

(52) U.S. Cl. CPC B32B 38/18

(57) ABSTRACT

A bonding fixture is used for fixing a flexible panel having a side edge comprising an edge part and corner parts, and an edge of at least one of the two corner parts is curve. The bonding fixture comprises a fixture body comprising a first profiling base configured for supporting the edge part; and a second profiling base arranged at at least one end of the first profiling base in a first direction, a length of the second profiling base in the first direction is equal to that of the corner parts in the first direction; the second profiling base is provided with a second profiling part configured for supporting the corner parts; in a second direction, the second profiling part extends beyond the first profiling base in a direction away from a center of the bonding fixture, and the second direction is perpendicular to the first direction.

### CROSS REFERENCE OF RELATED APPLICATIONS

The application claims priority to Chinese Patent Application No. 202110240751.0, entitled “BONDING FIXTURE AND BONDING DEVICE WITH THE SAME”, filed with the China National Intellectual Property Administration on Mar. 4, 2021, which is incorporated herein by reference in its entirety.

### TECHNICAL FIELD

The disclosure relates to the technical field of curved surface bonding, in particular to a bonding fixture and a bonding device with the same.

### BACKGROUND

In related arts, in the cover plate bonding (CG bonding) process, the bonding effect between a flexible panel and curved cover plate may affect the product yield.

### SUMMARY

The disclosure provides a bonding fixture and a bonding device with the same.

A bonding fixture according to a first aspect of the disclosure is used for fixing a flexible panel, wherein one side edge of the flexible panel comprises an edge part and corner parts, the edge part extends in a first direction, two corner parts are arranged at two ends of the edge part in the first direction, and an edge of at least one of the two corner parts is curve; and the bonding fixture comprises: a fixture body extending in the first direction and comprising a first profiling base, wherein the first profiling base is provided with a first profiling part on one side edge in a second direction, and the first profiling base is configured for supporting the edge part; and a second profiling base arranged at at least one end of the first profiling base in the first direction, wherein a length of the second profiling base in the first direction is equal to a length of the corner parts in the first direction, the second profiling base is provided with a second profiling part on one side edge in the second direction, and the second profiling part is configured for supporting the corner parts; in the second direction, the second profiling part extends out of the first profiling base in a direction away from a center of the bonding fixture, and the second direction being perpendicular to the first direction.

In some embodiments, the first profiling base is provided with the second profiling bases at both ends in the first direction.

In some embodiments, a quantity of the first profiling base is one.

In some embodiments, a quantity of the first profiling bases is two, and two first profiling bases are arranged side by side in the second direction.

In some embodiments, the bonding fixture is symmetrical about a first centerline and a second centerline, the first centerline extends in the first direction, and the second centerline extends in the second direction.

In some embodiments, the second profiling base is in sliding fit with the fixture body in the second direction, to adjust the length of the second profiling part beyond the first profiling part in the second direction.

In some embodiments, the edges of the corner parts are cambered, the area of a right-angled part corresponding to the corner parts is S1, the area of each of the corner parts is S2, the length of the second profiling part beyond the first profiling part in the second direction is L, the length of the second profiling base in the first direction is H, and S1−S2=L*H.

In some embodiments, the fixture body further comprises: a foundation, wherein the first profiling base and the second profiling base are mounted on the foundation, the foundation comprises a foundation part and a support part, the foundation part supporting bottoms of the first profiling base and the second profiling base, and the support part is arranged on an upper side of the foundation part and is configured for supporting the flexible panel.

In some embodiments, the second profiling base is in sliding fit with the first profiling base and/or the foundation part in the second direction, to adjust a distance between the second profiling base and the support part in the second direction.

In some embodiments, under the condition that the second profiling base and the support part are spaced apart, a stopper is arranged between the second profiling base and the support part and abuts against the second profiling base and the support part.

In some embodiments, the stopper is a silicon steel piece, the silicon steel piece comprises one or more silicon steel sheets.

In some embodiments, under the condition that the silicon steel piece comprises a plurality of silicon steel sheets, the plurality of silicon steel sheets are stacked in the second direction.

In some embodiments, the thickness of the silicon steel sheet is 0.1 mm.

In some embodiments, the flexible panel is configured for bonding with curved cover plate with one above the other, and an included angle between a tangent line at a corresponding outer edge of the curved cover plate in the second direction and a horizontal line is θ, the included angle θ satisfies: 150°≤θ<180°, where the included angle θ is located at a lower side of the horizontal line and at a side, away from the curved cover plate, of the tangent line.

A bonding device according to a second aspect of the disclosure comprises: a first fixture configured for fixing curved cover plate; and a second fixture which is the bonding fixture according to the first aspect, wherein the second fixture is arranged opposite to the first fixture and configured for fixing a flexible panel, and the flexible panel is configured for bonding with the curved cover plate.

Additional aspects and advantages of the disclosure will be set forth in part in the description that follows, and in part will be obvious from the description that follows, or may be learned by practice of the disclosure.

### BRIEF DESCRIPTION OF THE DRAWINGS

The above and/or additional aspects and advantages of the disclosure will become apparent and be easily understood from the description of embodiments taken in conjunction with the following drawings, in which:

FIG. 1 is a diagram of a bonding fixture according to an embodiment of the disclosure;

FIG. 2 is a diagram of a flexible panel matched with the bonding fixture shown in FIG. 1, and the area of the shaded part in the figure is S1-S2; and

FIG. 3 is another diagram of the bonding fixture shown in FIG. 1.

### DETAILED DESCRIPTION

Embodiments of the disclosure are described in detail below, examples of which are shown in the accompanying drawings, in which identical or similar reference signs denote identical or similar elements or elements having identical or similar functions throughout. The embodiments described below with reference to the drawings are exemplary ones merely for explaining the disclosure, and should not be understood as limiting the disclosure.

The following provides many different embodiments or examples for implementing different structures of the invention. In order to simplify the disclosure of the invention, components and arrangements of specific examples are described below. Of course, they are only examples and are not intended to limit the invention. In addition, the invention may repeat reference signs and/or letters in different examples, and such repetition is for the sake of simplicity and clarity, and does not itself indicate the relationship between the various embodiments and/or arrangements discussed. In addition, the invention provides examples of various specific processes and materials, but those of ordinary skill in the art may realize the application of other processes and/or the use of other materials.

A bonding fixture 100 according to an embodiment of a first aspect of the disclosure will be described below with reference to the drawings. The bonding fixture 100 may be used in a CG bonding process, and in the CG bonding process, the bonding fixture 100 may be used to fix a flexible panel 101. It may be understood that in the CG bonding process, when the flexible panel 101 and curved cover plate are bonded with one above the other, the bonding fixture 100 may be used as a lower fixture.

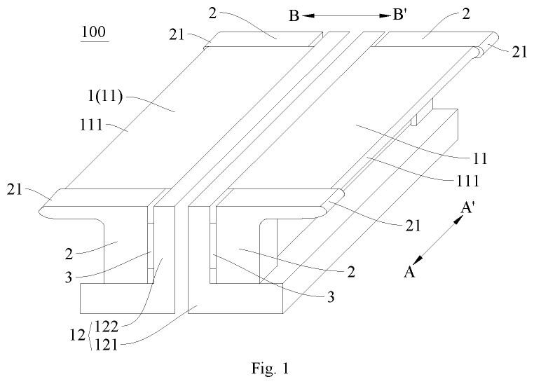

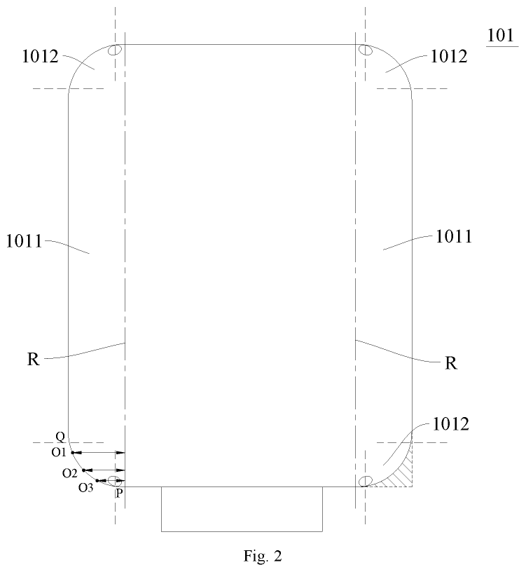

As shown in FIG. 2, one side edge of the flexible panel 101 comprises an edge part 1011 and corner parts 1012. The edge part 1011 extends in a first direction (for example, AA′ direction in FIG. 1), and two corner parts 1012 are respectively arranged at both ends of the edge part 1011 in the first direction, that is, one end of the edge part 1011 in the first direction is provided with one corner part 1012, and the other end of the edge part 1011 in the first direction is provided with the other corner part 1012. At least one of the two corner parts 1012 at both ends of the edge part is curve, so at least one of the two corner parts 1012 is a non-right-angled part. A “right-angled part” may be understood as the corner part 1012 whose edges are two line segments perpendicular to each other.

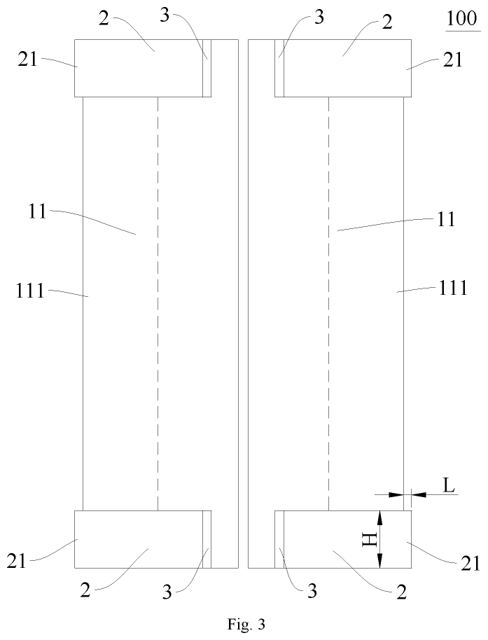

As shown in FIGS. 1 and 3, the bonding fixture 100 comprises a fixture body 1 extending in the first direction, the fixture body 1 comprises a first profiling base 11, one side edge of the first profiling base 11 in a second direction (for example, BB′ direction in FIG. 1) is provided with a first profiling part 111, and the first profiling part 111 is suitable for supporting the edge part 1011. In the CG bonding process, the first profiling part 111 is used for bonding the edge part 1011. The second direction is perpendicular to the first direction.

The bonding fixture 100 also comprises a second profiling base 2 arranged at at least one end of the first profiling base 11 in the first direction, and either one end of the first profiling base 11 in the first direction is provided with the second profiling base 2 or both ends of the first profiling base 11 in the first direction are respectively provided with the second profiling bases 2. One side edge of the second profiling base 2 in the second direction is provided with a second profiling part 21 suitable for supporting the corner parts 1012. In the CG bonding process, the second profiling part 21 is used for bonding the corner parts 1012, the length of the second profiling base 2 in the first direction is preferably equal to that of the corner parts 1012 in the first direction, then the length of the second profiling part 21 in the first direction is equal to the length of the corner parts 1012 in the first direction, so as to ensure that the second profiling part 21 may better meet the bonding requirements of the corner parts 1012, and the second profiling part 21 will not affect the bonding of the edge part 1011.

The inventors of the application found through research that when the corner part 1012 of the flexible panel 101 is a right-angled part, no bubble is generated at the corner part 1012 in the CG bonding process, while when the corner part 1012 of the flexible panel 101 is a non-right-angled part, an outer edge of the corner part 1012 extends along a curve, so that the bending radius of any position on the outer edge of the corner part 1012 in the CG bonding process is different from that of other positions on the outer edge of the corner part 1012, the smaller the bending radius is, the greater the bending stress will be, which will lead to inadequate bonding and profiling, and thus opening bubbles are produced. For example, in the example of FIG. 2, the outer edge of the corner part 1012 is an arc, and three points O1, O2 and O3 are randomly selected on the arc; and in the bonding process, the bending stresses at the three points are all different, the bending radius R1 at point O1>the bending radius R2 at point O2>the bending radius R3 at point O3, the bending stress F1 at point O1<the bending stress F2 at point O2<the bending stress F3 at point O3, so opening bubbles are more likely to occur at point O1 than at the other two points. Of course, the edge of the corner part 1012 may also be of other curved structures, not limited to arcs.

It can be seen that the flexible panel 101 has a bending line R, and if the edge of the corner part 1012 has a starting point P and an end point Q and the end point Q is connected with the edge part 1011, opening bubbles are more likely to occur at the starting point P than at other positions.

Based on the above analysis, the second profiling part 21 extends beyond the first profiling part 111 in a direction away from a center of the bonding fixture 100 in the second direction, so that the second profiling part 21 and the first profiling part 111 are located on the same side of the bonding fixture 100, and a distance between the second profiling part 21 and the center of the bonding fixture 100 is larger than that between the first profiling part 111 and the center of the bonding fixture 100 in the second direction. In other words, in the second direction, an end face of an end of the second profiling part 21 away from the center of the bonding fixture 100 is located outside an end face of an end of the first profiling part 111 away from the center of the bonding fixture 100, so that in the bonding process, the second profiling part 21 may better support the corner part 1012, especially a starting position of the edge of the corner part 1012, thereby improving the stress distribution of the corner part 1012. Therefore, the stress distribution at the edge of the corner part 1012 is relatively balanced, and the stress difference at the edge of the corner part 1012 is reduced, thereby effectively reducing the generation of opening bubbles (or bonding bubbles), avoiding product defects caused by bubbles, and further improving the bonding yield of products.

The direction “outside” may be understood as a direction away from the center of the bonding fixture 100 in the second direction.

Therefore, according to the bonding fixture 100 of the embodiment of the disclosure, by allowing the second profiling part 21 to extend beyond the first profiling part 111 in the direction away from the center of the bonding fixture 100 in the second direction, the second profiling part 21 may improve the stress distribution of the corner part 1012 in the bonding process, so that the stress distribution of the edge of the corner part 1012 is more balanced, thus effectively reducing the generation of bubbles in the bonding process of the flexible panel 101, and improving the bonding yield of products.

In addition, the inventors of the application have conducted comparison validation on this application and other solutions, which are as follows: in the second direction, the second profiling part extends to be flush with the first profiling part in the direction away from the center of the bonding fixture, so that the end face of the end of the second profiling part away from the center of the bonding fixture is flush with the end face of the end of the first profiling part away from the center of the bonding fixture; and when the edge of the corner part 1012 is curve, the ratio of defective bubbles in the corner part 1012 reaches 60% when bonding fixtures of other solutions are used for bonding, but the ratio of defective bubbles in the corner part 1012 is reduced to 8% when the bonding fixture 100 of this application is used for bonding, so the effect is remarkable.

In some embodiments, as shown in FIGS. 1-3, both ends of the first profiling base 11 in the first direction are provided with the second profiling bases 2, so when the edges of the corner parts 1012 at both ends of the edge part 1011 in the first direction are both curves, the bonding fixture 100 may be used for the bonding of the flexible panel 101 and corresponding curved cover plate, so that the bonding fixture 100 has good applicability and practicability.

Of course, it can be understood that when the edge of the corner part 1012 at one end of the edge part 1011 in the first direction is curve, the bonding fixture 100 may be provided with the second profiling base 2 at one end of the first profiling base 11 in the first direction as required. Therefore, the structural design of the bonding fixture 100 is flexible, so as to better meet the practical application.

For example, when both ends of the first profiling base 11 in the first direction are provided with the second profiling bases 2, one or two first profiling bases 11 may be arranged. In the example shown in FIGS. 1 and 3, two first profiling bases 11 are arranged side by side in the second direction, and four second profiling bases 2 are arranged, wherein two second profiling bases 2 are arranged at both ends of one of the first profiling bases 11, and the other two second profiling bases 2 are arranged at two ends of the other first profiling base 11; and the two second profiling bases 2 located on the same side of the two first profiling bases 11 may be arranged side by side in the second direction, the two second profiling bases 2 located on the same side of the two first profiling bases 11 may be arranged in a flush manner in the first direction, so that the four second profiling bases 2 may better support the four corner parts 1012 of the flexible panel 101, and the edges of the four corner parts 1012 are all curves, so that the bonding fixture 100 may better adapt to the flexible panel 101.

In some embodiments, as shown in FIGS. 1 and 3, the bonding fixture 100 is symmetrical about a first centerline and a second centerline, with the first centerline extending in the first direction and the second centerline extending in the second direction, and the flexible panel 101 is generally of an axisymmetric structure, so that the bonding fixture 100 may better adapt to the flexible panel 101.

It can be understood that if the bonding fixture 100 is symmetrical about the first centerline, another side edge of each second profiling base 2 in the second direction is also provided with a second profiling part 21, or each second profiling base 2 corresponds to another second profiling base 2 and the two second profiling bases are symmetrical with respect to the first centerline. For example, when both ends of the first profiling base 11 in the first direction are provided with the second profiling bases 2, four second profiling bases 2 are arranged, and two second profiling bases 2 located on the same side of the first profiling base 11 in the first direction may be symmetrical about the first centerline. In addition, if the bonding fixture 100 is symmetrical about the first centerline, another side edge of the first profiling base 11 in the second direction is also provided with a first profiling part 111, or two first profiling bases 11 are symmetrical about the first centerline.

Similarly, if the bonding fixture 100 is symmetrical about the second centerline, both ends of each first profiling base 11 in the first direction are provided with the second profiling bases 2, and in this case, one or two first profiling bases 11 are arranged.

In some embodiments, as shown in FIGS. 1 and 3, the second profiling base 2 and the fixture body 1 are in sliding fit in the second direction to adjust the length of the second profiling part 21 beyond the first profiling part 111 in the second direction, so that the bonding fixture 100 may adapt to flexible panels 101 with different bonding requirements, and the applicability of the bonding fixture 100 is improved.

It can be understood that the second profiling base 2 may move relative to the fixture body 1 through a sliding assembly, and in this case, the second profiling base 2 may be locked relative to the fixture body 1 through the sliding assembly itself, or the second profiling base 2 may be locked relative to the fixture body 1 through additional locking members such as bolts. The structure of the sliding assembly is not particularly limited, as long as the relative movement between the second profiling base 2 and the fixture body 1 in the second direction is realized.

In some embodiments, as shown in FIGS. 2 and 3, the edge of the corner part 1012 is an arc, the area of a right-angled part corresponding to the corner part 1012 is S1, the area of the corner part 1012 is S2, the length of the second profiling part 21 beyond the first profiling part 111 in the second direction is L, the length of the second profiling base 2 in the first direction is H, and S1−S2=L*H. Therefore, the stress distribution at the edge of the corner part 1012 is further improved, so that the bonding fixture 100 may better adapt to the flexible panel 101, and the generation of bonding bubbles is effectively reduced.

It should be noted that “the right-angled part corresponding to the corner part 1012” may be formed in such a way that on the basis of the corner part 1012, tangent lines are respectively made at two end points of the arched edge of the corner part 1012, the two tangent lines are perpendicular and intersect at a point outside the corner part 1012, and line segments between the intersection of the two tangent lines and the end points of the arc are taken as edges to form a right-angled part corresponding to the original corner part 1012.

It can be understood that when the second profiling base 2 is in sliding fit with the fixture body 1 in the second direction, the length L of the second profiling part 21 beyond the first profiling part 111 in the second direction may be adjusted, so that the length L may be flexibly adjusted during debugging, allowing the bonding fixture 100 to adapt to flexible panels 101 with different bonding requirements, thus improving the practicability and compatibility of the bonding fixture 100 and avoiding repeated processing of the bonding fixture 100.

In addition, because there may be some errors in products and/or the bonding fixture 100 and in the calculation of the area difference S1−S2, the length L of the second profiling base 2 beyond the first profiling base 11 in the second direction may be specifically adjusted according to the actual bonding needs.

In some embodiments, as shown in FIGS. 1 and 3, the fixture body 1 further comprises a foundation 12, and the first profiling base 11 and the second profiling base 2 are both installed on the foundation 12, so that the fixture body 1 and the second profiling base 2 form a whole easily and the bonding fixture 100 moves easily. Furthermore, the foundation 12 can support the first profiling base 11 and the second profiling base 2 to a certain extent, thus ensuring the bearing capacity of the bonding fixture 100.

For example, as shown in FIGS. 1 and 3, the foundation 12 comprises a foundation part 121 and a support part 122, wherein the foundation part 121 supports the bottoms of the first profiling base 11 and the second profiling base 2, and the support part 122 is arranged on an upper side of the foundation part 121 and is suitable for supporting the flexible panel 101, thus ensuring that the bonding fixture 100 reliably supports the flexible panel 101.

It can be understood that when the second profiling base 2 is movable relative to the fixture body 1 in the second direction, since the support part 122 supports the flexible panel 101, the supporting effect of the bonding fixture 100 on the flexible panel 101 will not deteriorate due to the movement of the second profiling base 2.

In some embodiments, as shown in FIGS. 1 and 3, the second profiling base 2 is in sliding fit with the first profiling base 11 and/or the foundation part 121 in the second direction to adjust a distance between the second profiling base 2 and the support part 122 in the second direction, so that the second profiling base 2 may be in sliding fit with the first profiling base 11, or the second profiling base 2 may be in sliding fit with the foundation part 121, or the second profiling base 2 may be in sliding fit with both the first profiling base 11 and the foundation part 121, which allows the bonding fixture 100 to adapt to flexible panels 101 with different bonding requirements, thus avoiding repeated processing of the bonding fixture 100.

As shown in FIGS. 1 and 3, when the second profiling base 2 is spaced apart from the support part 122, that is, when the second profiling base 2 moves to a position spaced apart from the support part 122, a stopper 3 is arranged between the second profiling base 2 and the support part 122 and abuts against both the second profiling base 2 and the support part 122. As the second profiling base 2 will be subjected to pressure during the bonding process, the second profiling base 2 tends to move towards the support part 122, and the stopper 3 between the second profiling base 2 and the support part 122 may limit the movement of the second profiling base 2 towards the support part 122, thus ensuring that the second profiling base 2 is limited reliably.

It can be understood that the stopper 3 may also reduce the locking force between the second profiling base 2 and the fixture body 1.

Optionally, the stopper 3 is a silicon steel piece, so as to ensure the reliability of the stopper 3 during use. The silicon steel piece comprises one or more silicon steel sheets, so the silicon steel piece has a simple structure and low cost. When the silicon steel piece comprises a plurality of silicon steel sheets, the plurality of silicon steel sheets are stacked in the second direction, so that the thickness of the silicon steel piece in the second direction can be easily adjusted, and the silicon steel piece is flexibly locked between the second profiling base 2 and the support part 122. In the description of this disclosure, “a plurality of” means two or more.

It can be understood that when the silicon steel piece comprises one silicon steel sheet, the thickness of the silicon steel piece in the second direction may be adjusted by replacing the silicon steel sheet.

Optionally, the thickness of the silicon steel sheet is 0.1 mm, and the adjustment precision of the thickness of the silicon steel piece in the second direction is easy to ensure on the premise of ensuring the bonding requirements of the flexible panel 101.

Of course, when the second profiling base 2 and the support part 122 are spaced apart, the stopper 3 may not be arranged between the second profiling base 2 and the support part 122, as long as it is ensured that the second profiling base 2 is stably limited at a required position.

In some embodiments, the flexible panel 101 is suitable for bonding with the curved cover plate with one above the other. For example, in the bonding process, the flexible panel 101 may be located below the curved cover plate, so that the flexible panel 101 and the curved cover plate are attached in the up-and-down direction. An included angle between a tangent line at a corresponding outer edge of the curved cover plate in the second direction and a horizontal line is θ, θ satisfies 150°≤θ≤180°, where θ is located at a lower side of the horizontal line and at a side, away from the curved cover plate, of the tangent line, so the bonding fixture 100 may be applied to a large-angle bonding process. However, bubbles tend to occur at the corners of the flexible panel 101 in the large-angle bonding process. The bonding fixture 100 in this application can effectively reduce the generation of bonding bubbles, avoid product defects caused by the generation of bonding bubbles, and improve the bonding yield.

A bonding device according to the embodiment in a second aspect of the disclosure comprises a first fixture and a second fixture, the first fixture is used for fixing curved cover plate, the second fixture is arranged opposite to the first fixture and used for fixing a flexible panel, and the flexible panel 101 is suitable for bonding with the curved cover plate, so as to realize a CG bonding process, wherein the second fixture is the bonding fixture 100 according to the embodiment in the first aspect of the disclosure.

According to the bonding device of the embodiment of the disclosure, by adopting the bonding fixture 100 described above, the bonding yield of products may be improved.

Other structures and operations of the bonding device according to the embodiment of the disclosure are known to those of ordinary skill in the art and will not be described in detail here.

Referring to FIGS. 1-3, the bonding fixture 100 according to the embodiment of the disclosure will be described in detail with a specific embodiment. It may be understood that the following description is only an exemplary illustration, not a specific limitation on the invention.

As shown in FIG. 2, the flexible panel 101 is roughly of a square structure, two side edges of the flexible panel 101 in the second direction are each provided with an edge part 1011 and corner parts 1012, the edge parts 1011 extend in the first direction, both ends of each edge part 1011 in the first direction are each provided with a corner part 1012, and the edge of each corner part 1012 is an arc, wherein the first direction is perpendicular to the second direction.

As shown in FIGS. 1 and 3, the bonding fixture 100 is symmetrical about the first centerline and the second centerline, with the first centerline extending in the first direction and the second centerline extending in the second direction. The bonding fixture 100 comprises the fixture body 1, the second profiling base 2 and the stopper 3. The fixture body 1 comprises the first profiling base 11 and the foundation 12, and the first profiling base 11 and the second profiling base 2 are both installed on the foundation 12. The foundation 12 comprises the foundation part 121 and the support part 122, wherein the foundation part 121 supports the bottoms of the first profiling base 11 and the second profiling base 2, and the support part 122 is arranged on the upper side of the middle of the foundation part 121. Two sides of the support part 122 in the second direction are each provided with a first profiling base 11, and two ends of each first profiling base 11 in the first direction are each provided with a second profiling base 2.

The upper surfaces of the first profiling base 11, the second profiling base 2 and the support part 122 are arranged in a flush manner to support the flexible panel 101. One side edge, away from the support part 122, of each first profiling base 11 in the second direction is provided with a first profiling part 111 for supporting the edge part 1011, and one side edge, away from the support part 122, of each second profiling base 2 in the second direction is provided with a second profiling part 21 for supporting the corner parts 1012.

As shown in FIGS. 1 and 3, in the second direction, the second profiling part 21 extends beyond the first profiling part 111 in the direction away from the center of the bonding fixture 100, and the second profiling base 2 is in sliding fit with the fixture body 1 in the second direction to adjust the length of the second profiling part 21 beyond the first profiling part 111 in the second direction. The stopper 3 is locked between the second profiling base 2 and the support part 122, and is a silicon steel piece.

Therefore, the bonding fixture 100 according to the embodiment of the disclosure may be applied to a large-angle bonding process, may reduce the generation of bonding bubbles and improve the bonding yield of products, has good applicability and compatibility, and eliminates the rework risk of the bonding fixture 100 caused by processing errors and calculation errors of the bonding fixture 100.

In the description of the disclosure, it should be noted that the orientation or position relationship indicated by the terms “center”, “length”, “width”, “thickness”, “upper”, “lower”, “front”, “rear”, “left”, “right”, “vertical”, “horizontal”, “top”, “bottom”, “inner” and “outer” are based on the orientation or position relationship shown in the drawings, only for convenience of describing the disclosure and simplifying the description, and do not indicate or imply that the device or element referred to must have a specific orientation, or be constructed and operated in a specific orientation, and therefore cannot be understood as a limitation of the disclosure. In addition, the features defined with “first” and “second” may explicitly or implicitly include one or more of the features.

In the description of the disclosure, it should be noted that, unless otherwise specified and limited, the terms “install” and “connect” should be understood in a broad sense, for example, they can be fixed connection, detachable connection, integrated connection, mechanical connection, electrical connection, direct connection, indirect connection through an intermediate medium and internal communication between two elements. For those of ordinary skill in the art, the specific meanings of the above terms in the disclosure can be understood according to specific situations.

In the description of this specification, descriptions with reference to the terms “one embodiment”, “some embodiments”, “schematic embodiments”, “examples”, “specific examples” or “some examples” mean that specific features, structures, materials or characteristics described in connection with this embodiment or example are included in at least one embodiment or example of this disclosure. In this specification, the schematic expression of the above terms does not necessarily refer to the same embodiment or example. Furthermore, the specific features, structures, materials or characteristics described may be combined in any one or more embodiments or examples in a suitable manner.

Although the embodiments of the disclosure have been shown and described, it will be understood by those of ordinary skill in the art that various changes, modifications, substitutions and variations can be made to these embodiments without departing from the principles and spirit of the disclosure, and the scope of which is defined by the claims and their equivalents.

1. A bonding fixture, wherein the bonding fixture is configured for fixing a flexible panel, the flexible panel has a side edge comprising an edge part and two corner parts, the edge part extends in a first direction, the two corner parts are arranged at two ends of the edge part in the first direction, respectively, an edge of at least one corner part of the two corner parts is curve, and the bonding fixture comprises:
a fixture body extending in the first direction and comprising a first profiling base, wherein the first profiling base is provided with a first profiling part on one side edge in a second direction, and the first profiling base is configured for supporting the edge part; and
a second profiling base arranged at at least one end of the first profiling base in the first direction, wherein a length of the second profiling base in the first direction is equal to a length of the corner parts in the first direction, the second profiling base is provided with a second profiling part on one side edge in the second direction, and the second profiling part is configured for supporting the corner parts, in the second direction, the second profiling part extends beyond the first profiling base in a direction away from a center of the bonding fixture, and the second direction is perpendicular to the first direction.

2. The bonding fixture according to claim 1, wherein the first profiling base is provided with the second profiling bases at both ends in the first direction.

3. The bonding fixture according to claim 2, wherein a quantity of the first profiling base is one.

4. The bonding fixture according to claim 2, wherein a quantity of the first profiling bases is two, and two first profiling bases are arranged side by side in the second direction.

5. The bonding fixture according to claim 1, wherein the bonding fixture is symmetrical about a first centerline and a second centerline, respectively, the first centerline extends in the first direction, and the second centerline extends in the second direction.

6. The bonding fixture according to claim 1, wherein the second profiling base is in sliding fit with the fixture body in the second direction, to adjust the length of the second profiling part beyond the first profiling part in the second direction.

7. The bonding fixture according to claim 1, wherein the edges of the corner parts are cambered, the area of a right-angled part corresponding to the corner parts is S1, the area of each of the corner parts is S2, the length of the second profiling part beyond the first profiling part in the second direction is L, the length of the second profiling base in the first direction is H, then S1−S2=L*H.

8. The bonding fixture according to claim 1, wherein the fixture body further comprises:
a foundation, wherein the first profiling base and the second profiling base are mounted on the foundation, the foundation comprises a foundation part and a support part, the foundation part supporting bottoms of the first profiling base and the second profiling base, and the support part is arranged on an upper side of the foundation part and is configured for supporting the flexible panel.

9. The bonding fixture according to claim 8, wherein the second profiling base is in sliding fit with the first profiling base and/or the foundation part in the second direction, to adjust a distance between the second profiling base and the support part in the second direction.

10. The bonding fixture according to claim 8, wherein under the condition that the second profiling base and the support part are spaced apart, a stopper is arranged between the second profiling base and the support part and abuts against the second profiling base and the support part.

11. The bonding fixture according to claim 10, wherein the stopper is a silicon steel piece, the silicon steel piece comprises one or more silicon steel sheets.

12. The bonding fixture according to claim 11, wherein under the condition that the silicon steel piece comprises a plurality of silicon steel sheets, the plurality of silicon steel sheets are stacked in the second direction.

13. The bonding fixture according to claim 11, wherein the thickness of the silicon steel sheet is 0.1 mm.

14. The bonding fixture according to claim 1, wherein the flexible panel is configured for bonding with curved cover plate with one above the other, and an included angle between a tangent line at a corresponding outer edge of the curved cover plate in the second direction and a horizontal line is θ, the included angle θ satisfies: 150°≤θ≤180°, where the included angle θ is located at a lower side of the horizontal line and at a side, away from the curved cover plate, of the tangent line.

15. A bonding device, comprising:
a first fixture configured for fixing curved cover plate; and
a second fixture which is the bonding fixture according to claim 1, wherein the second fixture is arranged opposite to the first fixture and configured for fixing a flexible panel, and the flexible panel is configured for bonding with the curved cover plate.
